(19) United States
(12) Patent Application Publication
(10) Pub. No.: US 2008/0037758 A1
(43) Pub. Date: Feb. 14, 2008

(54) Terminal apparatus and control method thereof

(76) Inventors: Shiro Saito, Tokyo (JP); Kazuhiko Seki, Tokyo (JP)

Correspondence Address: INTELLECTUAL PROPERTY / TECHNOLOGY LAW, PO BOX 14329, RESEARCH TRIANGLE PARK, NC, 27709, US

(21) Appl. No.: 11/485,212

(22) Filed: Jul. 12, 2006

(51) Int. Cl. H04M 7/00

(52) U.S. Cl. 379/220.01

(57) ABSTRACT

Terminal apparatus having a telephone function stores a correlation relationship between a prefix number of a first n digits of a telephone number decided based on a numbering plan and a total number of digits for a telephone number decided based on a numbering plan, for a plurality of types of numbering plans. In the event that a user starts to input a telephone number, the terminal apparatus refers to a correlation relationship of prefix numbers and a total number of digits for the telephone number, selects a prefix number matching with the number inputted by the user, acquires the total number of digits corresponding to the selected prefix number, and in the event that the number of digits for the number inputted by the user matches the acquired total number of digits, determines that input of the telephone number is complete and carries out call processing.

### BACKGROUND

The present invention relates to a terminal apparatus having a telephone function and a control method thereof, and particularly relates to superior call processing technology for the terminal apparatus.

With terminal apparatus such as IP telephones, ISDN telephones and mobile telephones of the related art having a telephone function sending dial data collectively to a network at the time of a call, a dedicated call key, for example, is provided as means for deciding the timing to the collective transmission of the dial data. A transition is then made to call processing taking the input operation of this call key as a trigger, or a configuration (a configuration where a time out is determined and a transition is made to call processing) may be adopted where a transition is made to call processing in the event that there is no input from the user over a predetermined time.

### SUMMARY

However, with the configuration where a call key is utilized and call processing is then gone to, compared to a PTSN telephone etc. where connection can be started even if only the telephone number is inputted, it is necessary to further operate the call key after pressing the telephone number, and this makes the calling operation complex. Further, in the case where the number of keys that can be provided at an apparatus is limited such as with a mobile telephone, a configuration where a call key is provided separately causes the number of keys to increase and is therefore not desirable.

On the other hand, with a configuration where a time out is determined and call processing is gone to, it is always necessary to wait for a fixed period of time until call processing starts, which is inconvenient.

It is therefore the object of the present invention to provide terminal apparatus capable of proceeding to call processing in a straightforward and rapid manner without a call key operation or timeout determination being necessary.

Terminal apparatus of the present invention is a terminal apparatus having a telephone function comprising a storage section for storing a correlation relationship between a number (hereinafter referred to as “prefix number”) of a first n digits of a telephone number decided based on a numbering plan and a total number of digits for a telephone number decided based on the numbering plan, for a plurality of types of numbering plans, an acquiring section for, in the event that a user starts to input a telephone number, referring to the correlation relationship, selecting a prefix number matching with the number inputted by the user, and acquiring the total number of digits corresponding to the selected prefix number, and a control section for carrying out control in the event that the number of digits of the number inputted by the user matches with the acquired total number of digits in such a manner that input of the telephone number is determined to be complete and call processing is carried out.

It is preferable for n=1 for all of the plurality of types of numbering plans.

It is also preferable for the values of n for at least two numbering plans of the plurality of types of numbering plans to be different.

Further, in the event that the acquired total number of digits is indeterminate, the control section performs control in such a manner that it is determined that input of a telephone number is complete in the event that there is no input from the user over a predetermined time or a predetermined call operation is not received from the user, and call processing is carried out.

It is also desirable for the storage section to be constructed so that the correlation relationship can be updated.

In a control method of the present invention, with a method for controlling terminal apparatus having a telephone function, a correlation relationship of a number (hereinafter referred to as “prefix number”) of a first n digits of a telephone number decided based on a numbering plan and a total number of digits for a telephone number decided based on the numbering plan is referred to for a plurality of types of numbering plans, a prefix number matching with the number inputted by the user is selected and a total number of digits corresponding to the selected prefix number is acquired, and in the event that the number of digits for the number inputted by the user matches with the total number of digits acquired, it is determined that input of the telephone number is complete, and call processing is carried out.

The control method of the present invention can be executed by a program operating on a computer. The program can be installed or loaded in an information processing section (computer) terminal apparatus are provided with either via various recording media such as a semiconductor memory such as a memory card, CD-ROM, or magnetic disc, or via a communication network.

In this specification, it is possible for one function to be implemented by two or more physical means, or for two or more functions to be implemented by one or more physical means.

According to the present invention, it is possible to provide terminal apparatus capable of proceeding to call processing in a straightforward and rapid manner without a call key operation or timeout determination being necessary.

### DESCRIPTION OF THE DRAWINGS

FIG. 1 is a block view of functions of an IP telephone of this embodiment.

FIG. 2 is a view showing an example of a numbering plan data table.

FIG. 3 is a plan view of a base unit of this embodiment.

FIG. 4 is a flowchart describing call processing of this embodiment.

### DETAILED DESCRIPTION

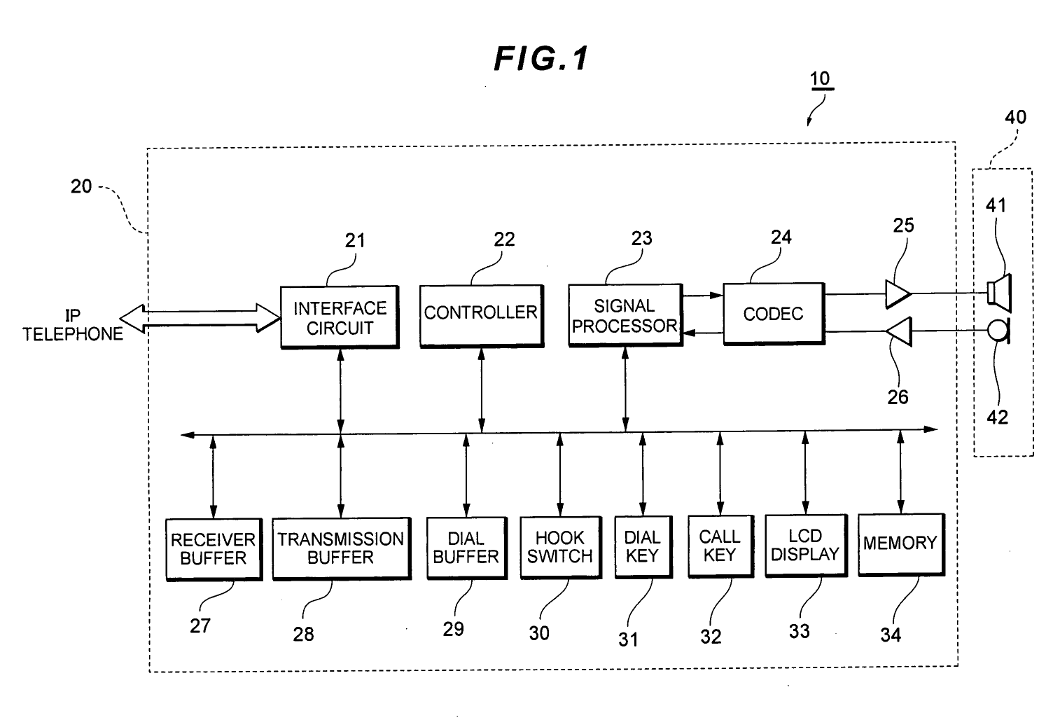

FIG. 1 is a block view of functions of an IP telephone 10 equipped with call control apparatus of this embodiment. As shown in the drawings, the IP telephone 10 is configured from a base unit 20 and handset 40 and functions as terminal apparatus having a telephone function as shown in the following.

The base unit 20 is principally configured from an interface circuit 21, controller 22, signal processor 23, codec 24, audio amplifier 25, audio amplifier 26, receiver buffer 27, and transmission buffer 28, etc.

The audio amplifier 26 is connected to a microphone 42 built-into the handset 40 and an audio signal inputted to the microphone 42 is amplified by the audio amplifier 26 and inputted to the codec 24. On the other hand, an audio signal outputted by the codec 24 is amplified by the audio amplifier 25 and provided via speaker 41 as an amplifier output. The codec 24 contains an A/D converter and a D/A converter, converts an analog audio signal outputted from audio amplifier 26 to a digital audio signal (audio data) and supplies this audio data to the signal processor 23, and converts audio data outputted by the signal processor 23 to an analog audio signal for output to the audio amplifier 25.

The signal processor 23 is an audio data compression/expansion circuit containing a DSP (Digital Signal Processor) etc. for compressing audio data supplied from a codec 24 for storage in a transmission buffer 28, expanding audio data supplied by the controller 22 after compression processing, and supplying the audio data after expanding to the codec 24. The interface circuit 21 is a circuit containing a MAC (Media Access Control) circuit, and a PHY (Physical Protocol) circuit, for subjecting transmission code transmitted from a transmission path such as IP networks to decoding processing for storage in the receiver buffer 27 and encoding audio data supplied by the controller 22 for transmission to a transmission path. Controller 22 is a circuit for executing call control etc. that reads out audio data stored in the transmission buffer 28 so as to put this audio data into the form of packets at predetermined frames and supply the audio data in the form of packets to the interface circuit 21, and extract audio data from the received data stored in receiver buffer 27 and supply this audio data to the signal processor 23.

Base unit 20 is also equipped with a dial buffer 29 for storing dial data, a hook switch (detection section) 30 for detecting whether the handset 40 is on-hook/off-hook, a dial key 31 for inputting dialing, a call key 32 for requesting a call, an LCD display 33 for displaying dial data etc., and a memory 34 for storing a numbering plan data table, etc.

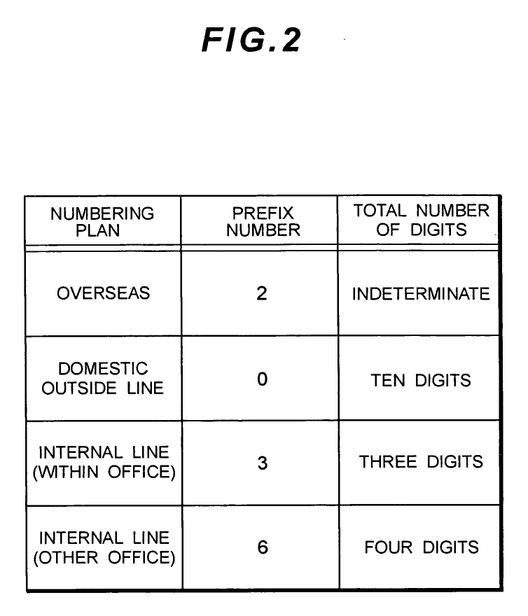

The numbering plan data table is a table for storing a correlation relationship of a first n digits of numbers (prefix numbers) for a telephone number decided based on numbering plan, and all digit numbers of a telephone number decided based on numbering plan (refer to FIG. 2), for a plurality of types of numbering plans. The value of n is preferably a number of digits where this numbering plan can be uniquely identified and the value of n may therefore be different depending on the numbering plan. In the example shown in FIG. 2, n=1 is adopted for the entire numbering plan in order to uniquely identify each numbering plan using the number of the first digit whichever the numbering plan. Further, as shown in the “overseas” numbering plan shown in the drawing, in the event that the total number of digits for a telephone number is indeterminate, a configuration is adopted where this is made to correspond to “indeterminate” data indicating that the digits are indeterminate.

It is preferable for the memory 34 to be re-writable memory, and in this event, it is preferable to adopt a configuration where it is possible to update a numbering plan data table using a user input or communication from outside.

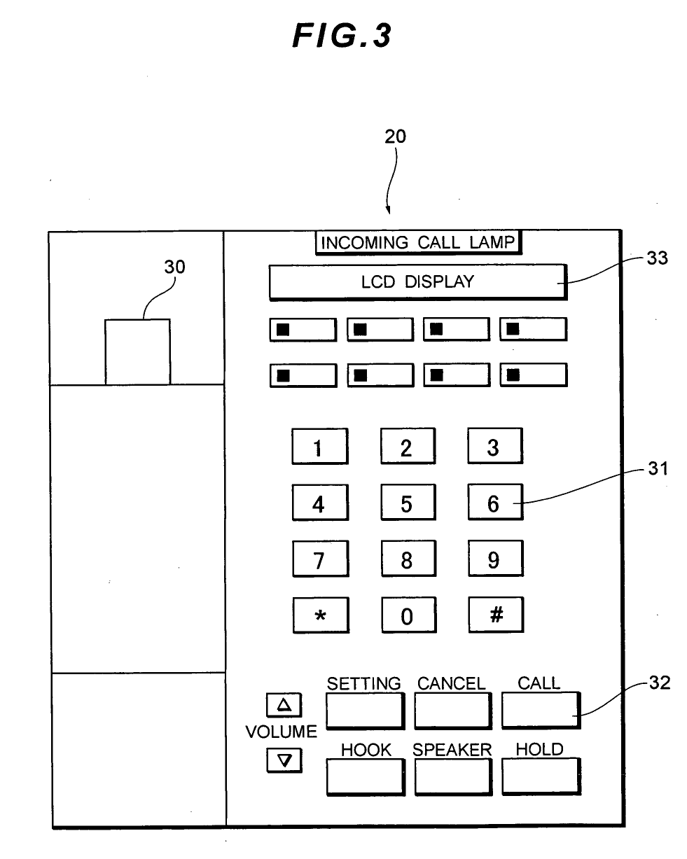

FIG. 3 is a plan view of the base unit 20. As shown in the same drawing, in addition to the hook switch 30, dial key 31, call key 32 and LCD display 33 described above, a volume adjustment key, setting key, cancel key, transfer/hook key, speaker key, and hold key etc. are provided at the base unit 20.

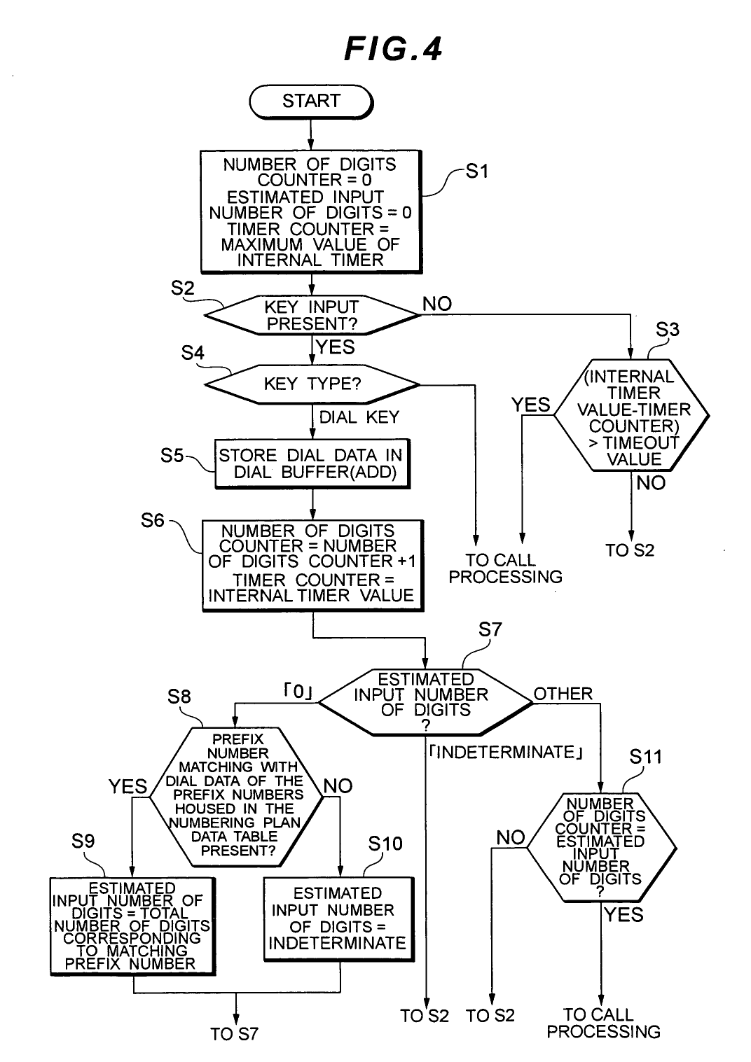

FIG. 4 is a flowchart describing call processing executed by the controller 22. Call processing is started up, for example, in the event that an off-hook state is gone to as a result of operation of the hook switch 30 etc., or in the event that a state where input of a telephone number by a user is gone to.

It is possible for the order of each step (including partial steps that are not assigned numerals) to be arbitrarily changed providing that this is within a range that does not conflict with the processing content, or each step may be executed in parallel. Further, various control processes other than call processes are executed by the controller 22 but in principle these processes are the same as for the related art and are not described in detail here.

Initially, a number of digits counter and an estimated input number of digits are set to zero and a maximum value for an internal timer is set at a timer counter as initial settings (step S1).

Next, the presence or absence of a key input is determined (step S2).

In the event that there is no key input, it is determined whether or not (internal timer value−timer counter)>timeout value (for example, four seconds) is satisfied (step S3). In the event that this is satisfied, call processing is gone to, and in the event that this is not satisfied, step S2 recurs.

The timeout value may be a variable. For example, in the event of a numbering plan where the total number of digits is “indeterminate” in the numbering plan data table, a configuration is adopted where a specific timeout value is stored so as to correlate with the numbering plan, and this value is read out and used.

In the event that a key input is detected in step S2, the type of key pressed is checked (step S4).

In the event that the pressed key is a call key 32, the call pressing is gone to.

On the other hand, in the event that the pressed key is a dial key 31, dial data is stored in (added to) the dial buffer 29 (step S5). Further, 1 is added to the number of digits counter and it is taken that the timer counter=the internal timer value (step S6).

Next, the estimated input number of digits is checked (step S7).

In step 7, in the event that the estimated input number of digits=0, the estimated input number of digits has not yet been acquired. The memory 34 is therefore referred to, and a determination is made as to whether or not there is a prefix number amongst the prefix numbers stored in the numbering plan data table matching with the dial data (pressed number) (step S8). In the event that n is a prefix number of 2 or more, comparison is made with the series of dial data stored in the dial buffer 29.

In the event that a prefix number matching with the dial data exists in the numbering plan data table, it can be determined that the telephone number for which input is currently progressing matches with a numbering plan corresponding to the matching prefix number. The total number of digits (all of the number of digits of the matching numbering plan) corresponding to the matching prefix number is then acquired from the numbering plan data table and set in the estimated input number of digits (step S9). It is desirable to adopt a configuration where, in the event that a matching prefix number exists, information (for example, a message such as “an attempt is being made to call an extension”) indicating the matching numbering plan is displayed at the LCD display 33. On the other hand, in the event that there is no matching prefix number, “indeterminate” is set to the estimated input number of digits (step S10). Step S7 is then returned to after setting the total number of digits for the matching numbering plan or “indeterminate” at the estimated input number of digits.

In step S7, in the event that the estimated input number of digits=“indeterminate”, step S2 is returned to.

In step S7, in the event that the estimated input number of digits is neither “0” nor “indeterminate”, a determination is made as to whether or not the number of digits counter=estimated input number of digits (step S11). In the event that this is established, it is determined whether input of the telephone number is complete and signal processing is gone to, while on the other hand, in the event that this is not established, step S2 is returned to.

The call processing can be configured in the same way as for the IP telephone of the related art, so that, for example, processing for setting dial data stored in the dial buffer 29 as a call destination number and transmitting the call message etc. is executed.

Further, although not shown in the drawings, in the event that the pressed key is not the call key 32 or the dial key 31, processing that is the same as for the related art is executed according to the type of key pressed. For example, in the event that the pressed key is a cancel key, the dial buffer 29 is cleared and either step S1 is proceeded to or the call processing is halted.

According to this embodiment, a configuration is adopted where the total number of digits for the numbering plan matching with the telephone number currently being inputted is acquired, this is taken as the estimated number of digits to be inputted for the telephone number currently being inputted, and call processing is proceeded to automatically at the stage where the number of digits for the inputted telephone number and the estimated number of digits inputted match. This means it is possible to go to call processing in a straightforward and rapid manner without a call key operation or time out determination being necessary, with the exception of cases where the total number of digits for a numbering plan is “indeterminate”.

The present invention is by no means limited to the above embodiment and application in various modifications is possible.

For example, a description is given taking the IP telephone 10 as an example but the call control apparatus of the present invention is also applicable to digital telephones and mobile telephones such as ISDN telephones where dial data is transmitted collectively.

What is claimed is:

1. Terminal apparatus having a telephone function, comprising:
a storage section for storing a correlation relationship between a prefix number of a first n digits of a telephone number decided based on a numbering plan and a total number of digits for a telephone number decided based on a numbering plan, for a plurality of types of numbering plans;
an acquiring section for, in the event that a user starts to input a telephone number, referring to the correlation relationship, selecting a prefix number matching with the number inputted by the user, and acquiring the total number of digits corresponding to the selected prefix number; and
a control section for carrying out control in the event that the number of digits of the number inputted by the user matches with the acquired total number of digits in such a manner that input of the telephone number is determined to be complete and call processing is carried out.

2. The terminal apparatus according to claim 1, wherein n=1 for all of the plurality of types of numbering plans.

3. The terminal apparatus according to claim 1, wherein the value of n is different for at least two numbering plans of the plurality of types of numbering plans.

4. The terminal apparatus as disclosed in claim 1, wherein the control section determines that input of a telephone number is complete and carries out call processing in the event that the acquired total number of digits is indeterminate, there is no input from the user for a predetermined period of time, or a predetermined call operation is received from the user.

5. The terminal apparatus as disclosed in claim 1, wherein the storage section is configured so as to be capable of updating the correlation relationship.

6. A method for controlling terminal apparatus having a telephone function, comprising the steps of:
storing a correlation relationship between a prefix number of a first n digits of a telephone number decided based on a numbering plan and a total number of digits for a telephone number decided based on a numbering plan, for a plurality of types of numbering plans;
selecting a prefix number matching with a number inputted by the user;
acquiring a total number of digits corresponding to the selected prefix number; and
carrying out control in the event that the number of digits of the number inputted by the user matches with the acquired total number of digits in such a manner that input of the telephone number is determined to be complete and call processing is carried out.
